(19) United States
(12) Patent Application Publication
(10) Pub. No.: US 2012/0091842 A1
(43) Pub. Date: Apr. 19, 2012

(54) Hydrodynamic bearing assembly and motor including the same

(75) Inventors: Young Tae Kim, Seoul (KR); Tae Young Choi, Gyunggi-do (KR)

(73) Assignee: SAMSUNG ELECTRO-MECHANICS CO., LTD., Suwon (KR)

(21) Appl. No.: 13/317,110

(22) Filed: Oct. 11, 2011

(30) Foreign Application Priority Data
Oct. 14, 2010 (KR) 10-2010-0100266

(51) Int. Cl. F16C 32/06; H02K 7/08

(52) U.S. Cl. 310/90; 384/123

(57) ABSTRACT

There is provided a fluid dynamic bearing assembly including: a hub coupled to a shaft and rotating together with the shaft; a sleeve supporting the shaft and including a storage groove formed in an upper surface thereof to thereby store oil between the sleeve and the hub; and a protrusion part protruding from one surface of the hub corresponding to the upper surface of the sleeve, allowing the oil to be sealed between the protrusion part and the sleeve, and having an oil interface formed in an outer radial direction thereof.

### CROSS-REFERENCE TO RELATED APPLICATIONS

This application claims the priority of Korean Patent Application No. 10-2010-0100266 filed on Oct. 14, 2010, in the Korean Intellectual Property Office, the disclosure of which is incorporated herein by reference.

### BACKGROUND OF THE INVENTION

1. Field of the Invention

The present invention relates to a fluid dynamic bearing assembly and a motor including the same, and more particularly, to a fluid dynamic bearing assembly in which reliability in terms of oil evaporation is secured and a sealing structure is improved, and a motor including the same.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized spindle motor is used.

In the small-sized spindle motor, a fluid dynamic bearing assembly has been used. A shaft, a rotating member of the fluid dynamic bearing assembly, and a sleeve, a fixed member thereof include oil interposed therebetween, such that the shaft is supported by fluid pressure generated in the oil.

In addition, according to the related art, the sleeve, a fixed member, and a hub, a rotating member, also include oil interposed in a micro clearance therebetween, and, when the hub rotates, friction caused by the oil occurs.

Since the friction generated at the time of rotation has an influence on the performance of the motor, a method of minimizing this friction is required.

In addition, when a temperature rises at the time of the rotation of the motor, a problem in which the oil deviates from a normal oil interface due to oil expansion may occur, having a large influence on the performance of the motor, due to oil leakage.

Particularly, when an external impact is applied, oil leakage has caused more serious problems, thereby reducing a lifespan of the motor.

Therefore, research into technology allowing the performance of a motor not to be influenced even in the case that a temperature rises or an external impact is applied, and minimizing friction at the time of the rotation of a rotating member to thereby improve the lifespan of the motor has been urgently required.

### SUMMARY OF THE INVENTION

An aspect of the present invention provides a fluid dynamic bearing assembly capable of preventing the performance of a motor from being deteriorated due to oil evaporation by securing an oil storage groove and improving a lifespan of the motor by preventing oil from being leaked due to external impact and temperature rise, and a motor including the same.

According to an aspect of the present invetion, there is provided a fluid dynamic bearing assembly including: a hub coupled to a shaft and rotating together with the shaft; a sleeve supporting the shaft and including a storage groove formed in an upper surface thereof to thereby store oil between the sleeve and the hub; and a protrusion part protruding from one surface of the hub corresponding to the upper surface of the sleeve, allowing the oil to be sealed between the protrusion part and the sleeve, and having an oil interface formed in an outer radial direction thereof.

The storage groove may be formed in an inner radial direction of the protrusion part.

The storage groove may be formed along a circumference of the upper surface of the sleeve.

The storage groove may be elongated in an inner radial direction.

The protrusion part may be formed along a circumference of the one surface of the hub corresponding to the upper surface of the sleeve.

The hub may include a wall part protruding from the one surface thereof, and a pumping groove may be formed in at least one of the wall part and an outer portion of the sleeve corresponding to the wall part such that the pumping groove pumps the oil toward the oil interface when the oil is leaked to the outer portion of the sleeve.

The pumping groove may have at least one of a spiral shape, a herrinbone shape, and a helix shape.

The fluid dynamic bearing assembly may further include a thrust plate coupled to a lower portion of the shaft to thereby provide thrust dynamic pressure to the shaft.

According to another aspect of the present invention, there is provided a motor including: a sleeve supporting a shaft and including a storage groove formed in an upper surface thereof to thereby store oil therein; a stator coupled to an outer peripheral surface of the sleeve and including a core having a coil wound therearound, the coil generating rotatary driving force; and a rotor including a magnet rotating together with the shaft, and having a protrusion part protruding from one surface thereof corresponding to the upper surface of the sleeve, allowing oil to be sealed between the protrusion part and the sleeve, and having an oil interface formed in an outer radial direction thereof.

The storage groove may be formed in an inner radial direction of the protrusion part.

The storage groove maybe formed along a circumference of the upper surface of the sleeve.

The storage groove maybe elongated in an inner radial direction.

The protrusion part maybe formed along a circumference of the one surface of the rotor corresponding to the upper surface of the sleeve.

The rotor may include a wall part protruding from the one surface thereof, and a pumping groove may be formed in at least one of the wall part and an outer portion of the sleeve corresponding to the wall part such that the pumping groove pumps the oil toward the oil interface when the oil is leaked to the outer portion of the sleeve.

The pumping groove may have at least one of a spiral shape, a herrinbone shape, and a helix shape.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a fluid dynamic bearing assembly according to an embodiment of the present invention;

FIG. 2 is a perspective view schematically showing a sleeve provided in a fluid dynamic bearing assembly according to an embodiment of the present invention;

FIG. 3 is a cut-away perspective view schematically showing a hub provided in a fluid dynamic bearing assembly according to an embodiment of the present invention;

FIG. 4 is a cross-sectional view schematically showing a motor including a fluid dynamic bearing assembly according to another embodiment of the present invention; and

FIGS. 5A and 5B are, respectively, a plan view and a bottom view schematically showing a thrust plate provided in a fluid dynamic bearing assembly according to another embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Further, like reference numerals will be used to designate like components having similar functions throughout the drawings within the scope of the present invention.

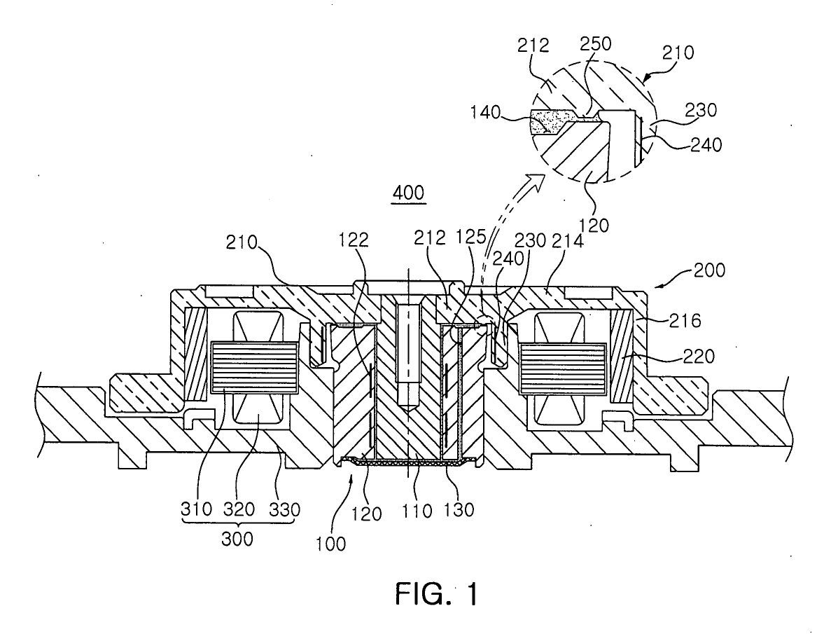

FIG. 1 is a cross-sectional view schematically showing a motor including a fluid dynamic bearing assembly according to an embodiment of the present invention.

Referring to FIG. 1, a motor 400 including a fluid dynamic bearing assembly according to an embodiment of the present invention may include a fluid dynamic bearing assembly 100 including a shaft 110 and a sleeve 120, a rotor 200 including a hub 210, and a stator 300 including a core 310 having a coil 320 wound therearound.

Hereinafter, the specific embodiments of the fluid dynamic bearing assembly 100 will be described. The motor 400 according to the present invention may have all the specific characteristics of each embodiment of the fluid dynamic bearing assembly 100.

The fluid dynamic bearing assembly 100 may include the shaft 110, the sleeve 120, and the hub 210, and the hub 210 may be a component configuring the fluid dynamic bearing assembly 100 while simultaneously configuring the rotor 200 to be described below.

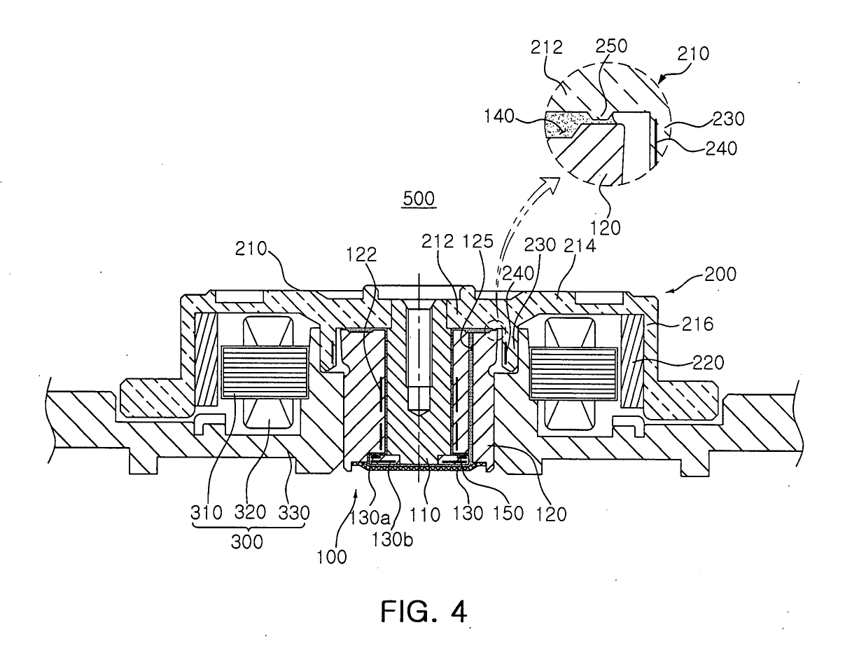

Terms with respect to directions will be first defined. As viewed in FIGS. 1 and 4, an axial direction refers to a vertical direction based on the shaft 110, and an outer radial direction and an inner radial direction refers to a direction toward an outer edge of the hub 210 based on the shaft 110 and a direction toward the center of the shaft 110 based on the outer edge of the hub 210, respectively.

The sleeve 120 may support the shaft 110 such that an upper end of the shaft 110 protrudes upwardly in the axial direction, and may be formed by forging Cu or Al or sintering Cu—Fe based alloy powder or SUS based powder.

Here, the shaft 110 is inserted into a shaft hole of the sleeve 120, having a micro clearance with therebetween. The micro clearance is filled with oil, and rotation of the rotor 200 may be more smoothly supported by a radial dynamic pressure groove 122 formed in at least one of an outer diameter of the shaft 110 and an inner diameter of the sleeve 120.

The radial dynamic pressure groove 122 is formed in an inner side of the sleeve 120, which is an inner portion adjacent to the shaft hole of the sleeve 120, and generates pressure to be deflected to one side at the time of rotation of the shaft 110.

However, the radial dynamic pressure groove 122 is not limited to being formed in the inner side of the sleeve 120 as described above but may also be formed in an outer diameter portion of the shaft 110. In addition, the number of radial dynamic pressure grooves is not limited.

Here, the radial dynamic pressure groove 122 may have at least one of a herringbone shape, a spiral shape, and a helix shape. However, the radial dynamic pressure groove 122 may have any shape as long as radial dynamic pressure may be generated.

An upper surface of the sleeve 120 may be provided with a storage groove 140 formed as a groove to thereby store oil therein. Since the storage groove 140 widens a clearance between the sleeve 120 and one surface of the hub 210 to be described below, it may serve to reduce friction between the sleeve 120 and the hub 210 to thereby improve the performance of the motor 400 according to the embodiment of the present invention.

In addition, the storage groove 140 secures a storage space preventing oil leakage in the case in which external impact is applied or a temperature rises at the time of driving of the motor 400 according to the embodiment of the present invention, whereby reliability in terms of oil evaporation may be secured.

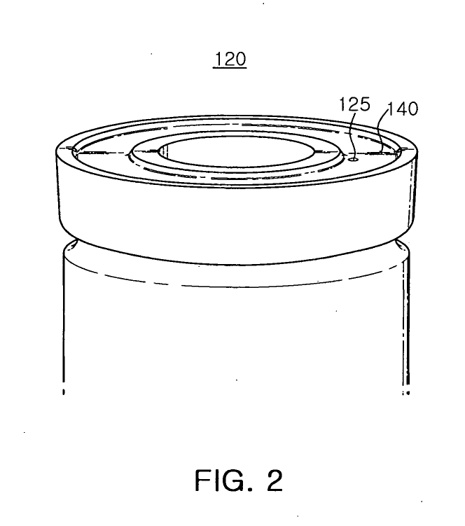

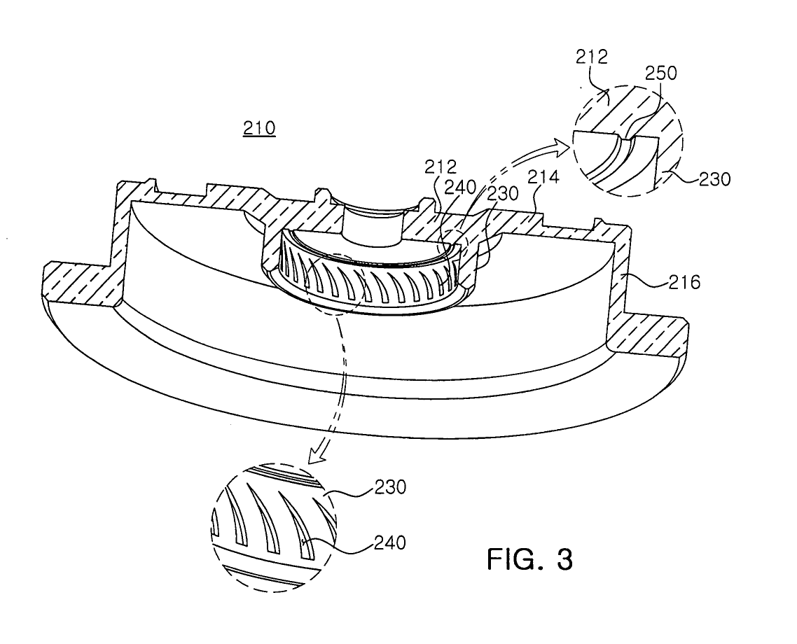

A detailed description thereof will be provided below with reference to FIGS. 2 and 3.

The sleeve 120 may include a circulation hole 125 formed therein so as to communicate oil between upper and lower portions thereof to disperse oil pressure in an inner portion of the fluid dynamic bearing assembly 100, thereby maintaining balance, and may move air bubbles, or the like, existing in the inner portion of the fluid dynamic bearing assembly 100, to be discharged by circulation.

Here, the sleeve 120 may include a base cover 130 coupled thereto at a lower portion thereof in the axial direction, having a clearance therebetween, wherein the clearance receives the oil therein.

The base cover 130 may receive the oil in the clearance between the base cover 230 and the sleeve 120 to thereby serve as a bearing supporting a lower surface of the shaft 110.

The hub 210 is a rotating member coupled to the shaft 110 and rotating together with the shaft 110. The hub 210 configures the rotor 200 while simultaneously configuring the fluid dynamic bearing assembly 100, so a detailed description thereof will be provided with a description of the rotor 200.

The rotor 200 is a rotating structure provided to be rotatable with respect to the stator 300 and may include the hub 210 having an annular ring-shaped magnet 220 provided on an outer peripheral surface thereof, and the annular ring-shaped magnet 220 corresponds to the core 310 to be described below, having a predetermined interval therebetween.

In other words, the hub 210 may be a rotating member coupled to the shaft 110 to thereby rotate together with the shaft 110.

Here, the magnet 220 may be a permanent magnet generating magnetic force having a predetermined strength by alternately magnetizing N and S poles thereof in a circumferential direction.

In addition, the hub 210 may include a first cylindrical wall part 212 fixed to the upper end of the shaft 110, a disk part 214 extended from an end portion of the first cylindrical wall part 212 in the outer radial direction, and a second cylindrical wall part 216 protruding downwardly from an end portion of the disk part 214 in the outer radial direction. An inner peripheral surface of the second cylindrical wall part 216 may be coupled to the magnet 220.

Here, the first cylindrical wall part 212 of the hub 210 may include a protrusion part 250 formed on one surface thereof corresponding to the upper surface of the sleeve 120. Oil may be sealed between an outer portion of the protrusion part 250 and the upper surface of the sleeve 120, and an oil interface may be formed in the outer radial direction of the protrusion part 250.

In addition, the hub 210 may include a wall part 230 extended downwardly in the axial direction so as to correspond to an upper portion of an outer surface of the sleeve 120.

The wall part 230 may include a pumping groove 240 formed in an inner peripheral surface thereof, and the pumping groove 240 pumps the oil toward the oil interface when the oil is separated from the oil interface owing to oil expansion due to an external impact or a temperature rise. The pumping groove 240 may also be formed in the upper portion of the outer peripheral surface of the sleeve 120 corresponding to the wall part 230.

Here, the protrusion part 250 and the pumping groove 240 will be described in detail with reference to FIGS. 2 and 3 in relation to the storage groove 140 of the sleeve 120.

The stator 300 may include the coil 320, the core 310, and a base member 330.

In other words, the stator 300 maybe a fixed structure including the coil 320 generating electromagnetic force having a predetermined magnitude when power is applied thereto, and a plurality of cores 310 having the coil 320 wound therearound.

The core 310 is fixedly disposed on an upper portion of the base member 330 including a printed circuit board (not shown) having circuit patterns printed thereon. A plurality of coil holes having a predetermined size are formed in the upper surface of the base member 330 corresponding to the winding coil 320 to penetrate through the base member 330 to thereby expose the winding coil 320 downwardly. The winding coil 320 may be electrically connected to the printed circuit board (not shown) so that external power is supplied thereto.

The outer peripheral surface of the sleeve 120 may be fixed to the base member 330, and the core 310 having the coil 320 wound therearound maybe inserted into the base member 330. In addition, the base member 330 and the sleeve 120 may be assembled by applying an adhesive to an inner surface of the base member 330 or an outer surface of the sleeve 120.

FIG. 2 is a perspective view schematically showing a sleeve provided in a fluid dynamic bearing assembly according to an embodiment of the present invention; and FIG. 3 is a cut-away perspective view schematically showing a hub provided in a fluid dynamic bearing assembly according to an embodiment of the present invention.

Referring to FIGS. 2 and 3, the sleeve 120 provided in the fluid dynamic bearing assembly according to the embodiment of the present invention may include the storage groove 140, and the hub 210 may include the protrusion part 250.

The storage groove 140 may be formed in the upper surface of the sleeve 120 and have a ring shape formed along a circumference of the upper surface of the sleeve 120.

In addition, the storage groove 140 may be formed to be elongated in the inner radial direction in the upper surface of the sleeve 120. However, a length and a depth of the storage groove 140 formed in the inner radial direction are not specifically limited.

Here, a micro clearance is formed between the upper surface of the sleeve 120 and one surface of the hub 210, and oil is interposed in the micro clearance.

Here, when the hub 210 rotates, friction caused by the oil occurs, and the upper surface of the sleeve 120 participates only in the friction.

Therefore, an interval between the sleeve 120 and the hub 210 is increased due to the storage groove 140 formed in the upper surface of the sleeve 120 to thereby reduce the friction generated at the time of the rotation of the hub 210, whereby the performance of the motor 400 according to the embodiment of the present invention may be improved.

In addition, since the storage groove 140 may serve as a storage space capable of storing the oil between the storage groove 140 and the hub 210, it prevents oil leakage in the case in which the external impact is applied or the temperature rises, whereby reliability in terms of the oil evaporation may be secured.

Here, the storage groove 140 maybe formed in the inner radial direction of the protrusion part 250 formed on one surface of the hub 210.

The protrusion part 250 may protrude from one surface of the hub 210 corresponding to the upper surface of the sleeve 120 to thereby allow the oil to be sealed between the outer portion of the protrusion part 250 and the upper surface of the sleeve 120, and the oil interface may be formed in the outer radial direction of the protrusion part 250.

The protrusion part 250 may be formed along the circumference of one surface of the hub 210 corresponding to the upper surface of the sleeve 120 and be formed in the inner radial direction of the wall part 230.

Here, the protrusion part 250 reduces an interval between the hub 210 and the upper surface of the sleeve 120 to thereby serve to prevent separation of the oil when an external impact is applied.

In addition, the wall part 230 of the hub 210 may include the pumping groove 240 formed in the inner peripheral surface thereof, and the pumping groove 240 pumps the oil toward the oil interface when the oil is separated from the oil interface owing to oil expansion due to the external impact or the temperature rise. The pumping groove 240 may also be formed in the upper portion of the outer peripheral surface of the sleeve 120 corresponding to the wall part 230.

That is, the pumping groove 240 may be formed in at least one of the upper portion of the outer peripheral surface of the sleeve 120 and the inner peripheral surface of the wall part 230. In addition, the pumping groove 240 may have a spiral shape, which is a semi-herringbone shape as shown in FIG. 3. However, the pumping groove 240 is not limited to having the above-mentioned shape but may have any shape as long as the oil leaked to the inner peripheral surface of the wall part 230 may be pumped toward the oil interface.

That is, the pumping groove may also have a herringbone shape or a helix shape.

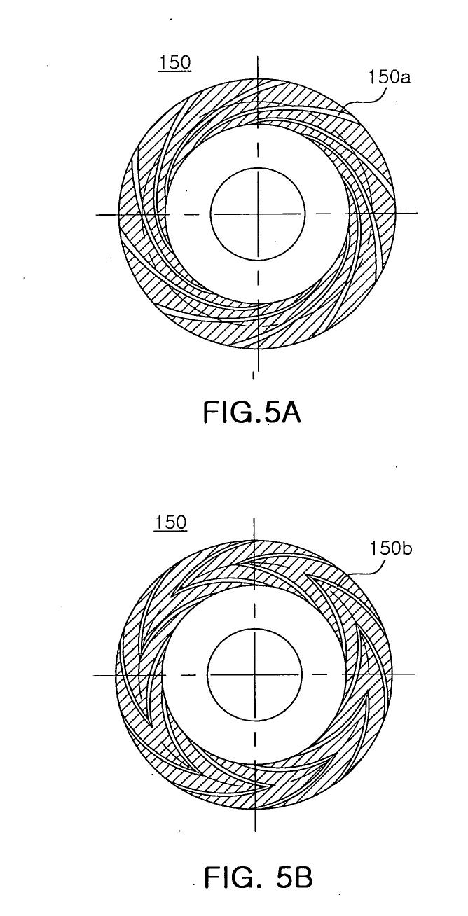

FIG. 4 is a cross-sectional view schematically showing a motor including a fluid dynamic bearing assembly according to another embodiment of the present invention; and FIGS. 5A and 5B are, respectively, a plan view and a bottom view schematically showing a thrust plate provided in a fluid dynamic bearing assembly according to another embodiment of the present invention.

Referring to FIG. 4, a motor 500 including a fluid dynamic bearing assembly according to another embodiment of the present invention has the same configuration and effect as those of the motor 400 including the fluid dynamic bearing assembly 100 according to the above-mentioned embodiment of the present invention with the exception of a thrust plate 150. Therefore, a detailed description thereof except for the thrust plate 150 will be omitted.

The thrust plate 150 is disposed on the lower portion of the sleeve 120 and includes a hole formed at the center thereof, the hole corresponding to a section of the shaft 110. The shaft 110 may be inserted into this hole.

Here, the thrust plate 150 may be separately manufactured to thereby be coupled to the shaft 110, but may be formed integrally with the shaft 110 when manufactured. The thrust plate 150 may be rotated together with the shaft 110 at the time of the rotation of the shaft 110.

The thrust plate 150 may include thrust dynamic pressure grooves 150a and 150b in upper and lower surfaces thereof, and the thrust dynamic pressure grooves 150a and 150b provide thrust dynamic pressure to the shaft 110. The thrust dynamic pressure groove 150a formed in the upper surface of the thrust plate 150 may have a spiral shape, and the thrust dynamic pressure groove 150b formed in the lower surface thereof may have a herringbone shape.

That is, in the case in which the circulation hole 125 is formed as shown in FIG. 4, the thrust dynamic pressure grooves 150a and 150b may be formed in the upper and lower surfaces of the thrust plate 150.

In other words, radial dynamic pressure is generated by the radial dynamic pressure groove 122 formed in the outer peripheral surface of the shaft 110 or the inner peripheral surface of the sleeve 120, and the entire oil pressure is generated downwardly in the axial direction due to the structure of the radial dynamic pressure groove 122.

The pressure is directed in the outer radial direction of the thrust plate 150, and part of this pressure is directed upwardly in the axial direction along the circulation hole 125 and the remaining part thereof is directed toward the lower surface of the thrust plate 150.

Therefore, part of the pressure is directed upwardly in the axial direction along the circulation hole 125, such that pressure, allowing the shaft 110 to be floated and rotate, is reduced.

Therefore, since thrust dynamic pressure needs to be supplemented in order to secure floating force of the shaft 110, the thrust dynamic pressure grooves 150a and 150b may be formed in the lower surface of the thrust plate 150 as well as in the upper surface thereof.

However, in a case in which the circulation hole 125 is not formed, there is no pressure lost along the circulation hole 125, and accordingly, the thrust dynamic pressure groove 150a may be formed only in the upper surface of the thrust plate 150. Even in this case, sufficient floating force may be secured.

However, the thrust dynamic pressure groove 150a formed in the upper surface of the thrust plate 150 may also be formed in the lower surface of the sleeve 120 corresponding to the upper surface of the thrust plate 150 or be formed in both of the upper surface of the thrust plate 150 and the lower surface of the sleeve 120.

In addition, as described above, the thrust dynamic pressure grooves 150a and 150b formed in the upper and lower surfaces of the thrust plate 150 may have a spiral shape and a herringbone shape, respectively. However, the thrust dynamic pressure grooves 150a and 150b are not limited to having the above-mentioned shapes but may have any shape as long as thrust dynamic pressure may be provided.

According to the embodiments of the present invention, friction between the sleeve 120 and the hub 210 at the time of the rotation of the rotating member including the hub 210 is reduced by the storage groove 140 formed in the upper surface of the sleeve 120, whereby the performance of the motor 400 or 500 may be improved.

In addition, the storage space of oil is increased due to the storage groove 140, whereby reliability in terms of oil evaporation may be secured.

Further, when the oil is deviated from the oil interface due to a temperature rise or an external impact, the leaked oil may return to the oil interface by the pumping groove 240 formed in the wall part 230 of the hub 210 or the outer peripheral surface of the sleeve 120 corresponding to the wall part 230.

Furthermore, the protrusion part 250 is formed on the hub 210 to prevent the separation of the oil due to the external impact, whereby the lifespan of the motor 400 or 500 according to the embodiment of the present invention may be maximized.

As set forth above, in a fluid dynamic bearing assembly and a motor including the same according to embodiments of the present invention, oil leakage due to a temperature rise and an external impact is prevented, whereby the performance of the motor may be improved.

In addition, friction between a hub, a rotating member, and a sleeve, a fixed member, is minimized, whereby the lifespan of the motor may be maximized.

While the present invention has been shown and described in connection with the embodiments, it will be apparent to those skilled in the art that modifications and variations can be made without departing from the spirit and scope of the invention as defined by the appended claims.

What is claimed is:

1. A fluid dynamic bearing assembly comprising:
a hub coupled to a shaft and rotating together with the shaft;
a sleeve supporting the shaft and including a storage groove formed in an upper surface thereof to thereby store oil between the sleeve and the hub; and
a protrusion part protruding from one surface of the hub corresponding to the upper surface of the sleeve, allowing the oil to be sealed between the protrusion part and the sleeve, and having an oil interface formed in an outer radial direction thereof.

2. The fluid dynamic bearing assembly of claim 1, wherein the storage groove is formed in an inner radial direction of the protrusion part.

3. The fluid dynamic bearing assembly of claim 1, wherein the storage groove is formed along a circumference of the upper surface of the sleeve.

4. The fluid dynamic bearing assembly of claim 1, wherein the storage groove is elongated in an inner radial direction.

5. The fluid dynamic bearing assembly of claim 1, wherein the protrusion part is formed along a circumference of the one surface of the hub corresponding to the upper surface of the sleeve.

6. The fluid dynamic bearing assembly of claim 1, wherein the hub includes a wall part protruding from the one surface thereof, and
a pumping groove is formed in at least one of the wall part and an outer portion of the sleeve corresponding to the wall part such that the pumping groove pumps the oil toward the oil interface when the oil is leaked to the outer portion of the sleeve.

7. The fluid dynamic bearing assembly of claim 6, wherein the pumping groove has at least one of a spiral shape, a herrinbone shape, and a helix shape.

8. The fluid dynamic bearing assembly of claim 1, further comprising a thrust plate coupled to a lower portion of the shaft to thereby provide thrust dynamic pressure to the shaft.

9. A motor comprising:
a sleeve supporting a shaft and including a storage groove formed in an upper surface thereof to thereby store oil therein;
a stator coupled to an outer peripheral surface of the sleeve and including a core having a coil wound therearound, the coil generating rotatary driving force; and
a rotor including a magnet rotating together with the shaft, and having a protrusion part protruding from one surface thereof corresponding to the upper surface of the sleeve, allowing oil to be sealed between the protrusion part and the sleeve, and having an oil interface formed in an outer radial direction thereof.

10. The motor of claim 9, wherein the storage groove is formed in an inner radial direction of the protrusion part.

11. The motor of claim 9, wherein the storage groove is formed along a circumference of the upper surface of the sleeve.

12. The motor of claim 9, wherein the storage groove is elongated in an inner radial direction.

13. The motor of claim 9, wherein the protrusion part is formed along a circumference of the one surface of the rotor corresponding to the upper surface of the sleeve.

14. The motor of claim 9, wherein the rotor includes a wall part protruding from the one surface thereof, and
a pumping groove is formed in at least one of the wall part and an outer portion of the sleeve corresponding to the wall part such that the pumping groove pumps the oil toward the oil interface when the oil is leaked to the outer portion of the sleeve.

15. The motor of claim 14, wherein the pumping groove has at least one of a spiral shape, a herrinbone shape, and a helix shape.
